(19) United States
(12) Patent Application Publication
(10) Pub. No.: US 2026/0322940 A1
(43) Pub. Date: Oct. 15, 2026

(54) IMAGE PROCESSING APPARATUS, DISPLAY APPARATUS, ELECTRONIC PAPER, IMAGE PROCESSING METHOD, AND NON-TRANSITORY COMPUTER READABLE MEDIUM

(71) Applicant: SHARP KABUSHIKI KAISHA, Sakai City (JP)

(72) Inventor: YOSHINORI MURAKAMI, Sakai City (JP)

(21) Appl. No.: 19/531,491

(22) Filed: Feb. 5, 2026

(30) Foreign Application Priority Data
Feb. 7, 2025 (JP) 2025-019277

(51) Int. Cl. H04N 1/405; H04N 1/409; H04N 1/52

(52) U.S. Cl. CPC H04N 1/405; H04N 1/409; H04N 1/52

(57) ABSTRACT

An image processing apparatus includes an image data acquirer that acquires image data, and a halftone processor that performs dither processing when the image data includes a character image or does not include a photographic image and performs error diffusion processing when the image data does not include a character image or includes a photographic image.

### CROSS-REFERENCE TO RELATED APPLICATION

The present application claims priority from Japanese Application JP2025-19277, the content of which is hereby incorporated by reference into this application.

### BACKGROUND OF THE INVENTION

### 1. Field of the Invention

The present disclosure relates to an image processing apparatus, a display apparatus, an electronic paper, an image processing method, and a non-transitory computer readable medium, and more particularly, to an image processing apparatus having a halftone (tone reproduction) processing function, a display apparatus including the image processing apparatus, an electronic paper including the image processing apparatus, an image processing method, and a non-transitory computer readable medium.

### 2. Description of the Related Art

Many of electronic papers have a resolution which is not particularly high as compared with a liquid crystal display, an organic EL display, or the like, and have a low number of output tones and a low number of output colors per pixel. Therefore, such electronic papers express tones and colors by area coverage modulation through error diffusion processing, dither processing, or the like.

In relation to a technique of expressing tones and colors by such area coverage modulation, as a technique in the related art for implementing a display system in which characters and the like expressed by halftone are easily visually recognized, a known display system includes a first image data generator that generates first image data from input color image data, a second image data generator that generates second image data obtained by performing area coverage modulation on the first image data, and a display processor that performs processing of displaying an image on an electronic paper based on the second image data. In the display system, the first data generator performs processing of enlarging a difference between a luminance of a first pixel and a luminance of a second pixel adjacent to the first pixel in the color image data.

As a technique in the related art for implementing an image processing apparatus that suppresses blurriness of color printing due to overlapping of multiple colors and prevents a tone from being conspicuous in a region with low saturation, a known printing apparatus includes a tone converter that, when it is determined that saturation of each pixel of input image data is larger than a predetermined saturation value, changes threshold values of a dither matrix so as to be different depending on respective color component values corresponding to the same pixel, and generates respective color component values of pixels constituting output image data based on a comparison result between respective changed threshold value and the respective color component value.

### SUMMARY OF THE INVENTION

Incidentally, in a large-sized electronic paper used for a poster or the like, in order to improve an advertising effect, not only a photographic image is enlarged, but also a character image is often displayed with large and thick characters so as to be easily read even when viewed from a distant position.

Such large and thick characters include a character having intermediate density, and when the character is output after the output color thereof is determined based on a result of error diffusion processing, the inside of the character may become non-uniform, which is not preferable. Therefore, in order to place importance on uniformity and secure resolution as much as possible, it is preferable to perform dither processing using a Bayer type threshold matrix on a character image.

However, for color characters, when three color components are processed using the same threshold matrix, there is a concern that the number of white/black pixels increases, and saturation decreases. On the other hand, for gray characters, when even one color component is processed using a different threshold matrix, there is a concern that chromatic pixels other than black and white pixels increase and gray reproducibility is reduced.

An aspect of the disclosure has been made in view of these problems, and provides an image processing apparatus, an image processing method, and a non-transitory computer readable medium capable of performing halftone processing of image data more appropriately than in the related art.

An aspect of the disclosure provides an image processing apparatus including; an image data acquirer that acquires image data; and a halftone processor that performs dither processing when the image data includes a character image or does not include a photographic image, and performs error diffusion processing when the image data does not include a character image or includes a photographic image.

Another aspect of the disclosure provides an image processing method including: acquiring image data; and performing dither processing when the image data includes a character image or does not include a photographic image, and performing error diffusion processing when the image data does not include a character image or includes a photographic image.

Still another aspect of the disclosure provides a non-transitory computer readable medium storing an image processing program that causes a processor of an image processing apparatus to execute processing including: acquiring image data; and performing dither processing when the image data includes a character image or does not include a photographic image, and performing error diffusion processing when the image data does not include a character image or includes a photographic image.

According to the aspect of the disclosure, it is possible to implement an image processing apparatus, an image processing method, and a non-transitory computer readable medium capable of performing halftone processing of image data more appropriately than in the related art by performing dither processing when the image data includes a character image or does not include a photographic image, and performing error diffusion processing when the image data does not include a character image or includes a photographic image.

### BRIEF DESCRIPTION OF THE DRAWINGS

FIG. 1 is an explanatory diagram illustrating a schematic configuration of an electronic paper system according to a first embodiment of the disclosure.

FIG. 2 is a block diagram illustrating a schematic configuration of an electronic paper illustrated in FIG. 1.

FIG. 3 is a block diagram illustrating a schematic configuration of an image processor in FIG. 1.

FIG. 4 is a flowchart illustrating an example of image processing by the image processor in FIG. 1.

FIG. 5 is a block diagram illustrating a schematic configuration of a brightness adjuster in FIG. 3.

FIG. 6 is a block diagram illustrating a schematic configuration of a halftone (tone reproduction) processor in FIG. 3.

FIG. 7 is a flowchart illustrating an example of halftone (tone reproduction) processing by the halftone (tone reproduction) processor in FIG. 3.

FIGS. 8A and 8B are tables each showing a correspondence relationship between quantized values of CMY values of respective pixels by an error diffusion processor in FIG. 6 and output colors of a display. FIG. 8A illustrates a correspondence relationship between the quantized values and the output colors of the display in a case where the number of output colors is eight, and FIG. 8B illustrates a correspondence relationship between the quantized values and the output colors of the display in a case where the number of output colors is six.

FIG. 9 is a table showing a correspondence relationship between CMY values after binarization of respective pixels through dither processing by a dither processor in FIG. 6 and output colors of the display.

FIG. 10 is an example of a Bayer type threshold matrix used in the dither processing by the dither processor in FIG. 6.

FIG. 11 is a flowchart illustrating an example of dither processing by a dither processor of an image processor of an electronic paper of a second embodiment of the disclosure.

FIGS. 12A and 12B are examples of a Bayer type threshold matrix used in the dither processing by the dither processor of the image processor of the electronic paper of the second embodiment of the disclosure. FIG. 12A illustrates a first threshold matrix for pixels of gray (C=M=Y) characters or a first threshold matrix of two components for pixels of color (not C=M=Y) characters. FIG. 12B illustrates a second threshold matrix of one component for pixels of color (C=M=Y) characters.

FIG. 13 is a table showing a correspondence relationship between CMY values after binarization of respective pixels through dither processing by a dither processor of an image processor of an electronic paper of a third embodiment of the disclosure and output colors of a display.

FIG. 14 is a table showing an example of combinations of three components of CMY to be subjected to dither processing using the first and second threshold matrices for each pattern of output colors (six colors) of the display of the electronic paper of the third embodiment of the disclosure.

### DETAILED DESCRIPTION OF THE INVENTION

In the disclosure, an “image processing apparatus” is an apparatus that performs image processing such as halftone processing on image data.

The “image data” may be any of image data including only a character image, image data including only a photographic image, and image data in which a character image and a photographic image are mixed. In a case where a character image and a photographic image are mixed in one image data, for example, dither processing or error diffusion processing may be performed in accordance with the presence or absence of a character image or a photographic image for each predetermined unit such as a pixel.

Furthermore, preferred aspects of the disclosure will be described.

In the image processing apparatus according to the disclosure, whether the image data includes a character image or whether the image data does not include a photographic image may be determined based on a user's setting.

Accordingly, it is possible to implement an image processing apparatus capable of performing halftone processing of image data more appropriately than in the related art by performing dither processing when the image data includes a character image or does not include a photographic image, and performing error diffusion processing when the image data does not include a character image or includes a photographic image, after determining whether the image data includes a character image or whether the image data does not include a photographic image based on the user's setting.

The image processing apparatus according to the disclosure may further include an image data determiner that determines whether the image data includes a character image or whether the image data does not include a photographic image and an image data analyzer that analyzes the image data, and the image data determiner may determine whether the image data includes a character image or whether the image data does not include a photographic image based on an analysis result of the image data analyzer.

Accordingly, it is possible to implement an image processing apparatus capable of performing halftone processing of image data more appropriately than in the related art by performing dither processing when the image data includes a character image or does not include a photographic image, and performing error diffusion processing when the image data does not include a character image or includes a photographic image, after determining whether the image data includes a character image or whether the image data does not include a photographic image based on the analysis result of the image data.

The image processing apparatus according to the disclosure may further include a color component determiner that determines, when the image data includes a character image or does not include a photographic image, whether three color component values of pixel data constituting the character image are the same, and the halftone processor may perform predetermined first dither processing on the pixel data when the three color component values of the pixel data are the same, and perform predetermined second dither processing different from the first dither processing on the pixel data when the three color component values of the pixel data are not the same.

Accordingly, it is possible to implement an image processing apparatus capable of performing halftone processing of image data more appropriately than in the related art by performing the first dither processing on the pixel value when the three color component values of the pixel data are the same, and performing the second dither processing different from the first dither processing on the pixel data when the three color component values of the pixel data are not the same.

In the image processing apparatus according to the disclosure, the first dither processing may be performed on all components of the three color component values using a predetermined first threshold matrix, and the second dither processing may be performed on at least one color component of the three color component values using a predetermined second threshold matrix different from the first threshold matrix.

Accordingly, it is possible to implement an image processing apparatus capable of performing halftone processing of image data more appropriately than in the related art by performing the first dither processing on all the components of the three color component values using the first threshold matrix, and performing the second dither processing on at least one color component of the three color component values using the second threshold matrix different from the first threshold matrix.

In the image processing apparatus according to the disclosure, the first threshold matrix and the second threshold matrix may be Bayer type threshold matrices.

Accordingly, it is possible to implement an image processing apparatus capable of performing halftone processing of image data more appropriately than in the related art by using the Bayer type threshold matrices as the first threshold matrix and the second threshold matrix.

The image processing apparatus according to the disclosure may further include an image data output unit that converts the image data processed by the halftone processor into output image data and outputs the output image data.

Accordingly, it is possible to implement an image processing apparatus capable of performing halftone processing of image data more appropriately than in the related art and capable of outputting an image with high reproducibility by further including the image data output unit that converts the image data processed by the halftone processor into output image data and outputs the output image data.

An aspect of the disclosure may be a display apparatus including the image processing apparatus and a display that displays an image based on the output image data.

In the disclosure, the “display apparatus” is not limited to the electronic paper as long as the display apparatus displays an image, and may be any device or terminal including a portable information terminal such as a smartphone or a tablet terminal, an electronic blackboard, an information display, a personal computer, or the like.

Accordingly, it is possible to implement a display apparatus including the image processing apparatus capable of performing halftone processing of image data more appropriately than in the related art.

An aspect of the disclosure may be an electronic paper including the image processing apparatus and a display that displays an image based on the output image data. In the electronic paper, the display includes color particles that move by being applied with a predetermined write voltage, and the image is displayed on the display by applying the write voltage to the color particles based on the output image data.

Accordingly, it is possible to implement an electronic paper including the image processing apparatus capable of performing halftone processing of image data more appropriately than in the related art.

Hereinafter, the disclosure will be described in further detail using the drawings. Note that the following description is illustrative in all aspects and should not be understood as limiting the disclosure.

### First Embodiment

### Schematic Configuration of Electronic Paper System 100 According to First Embodiment of Disclosure

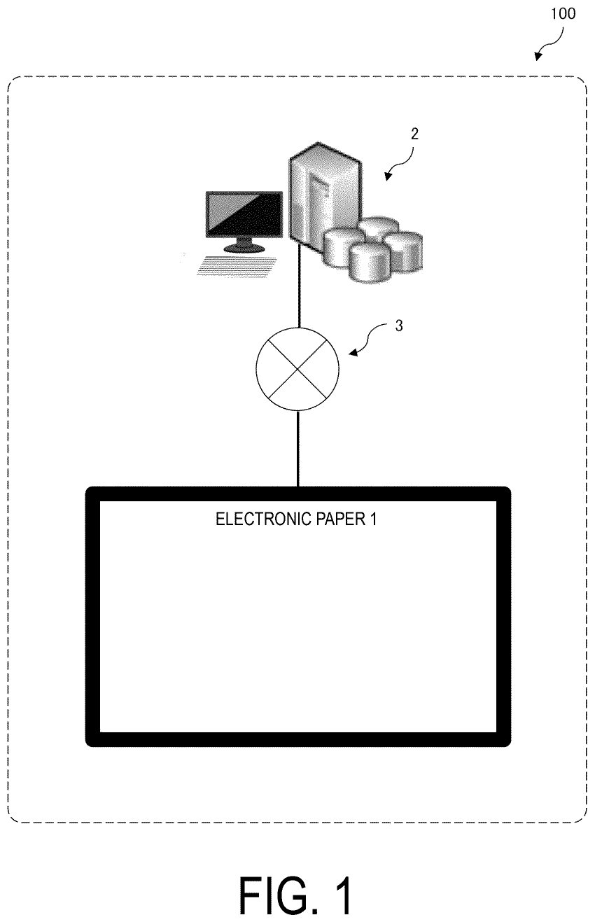

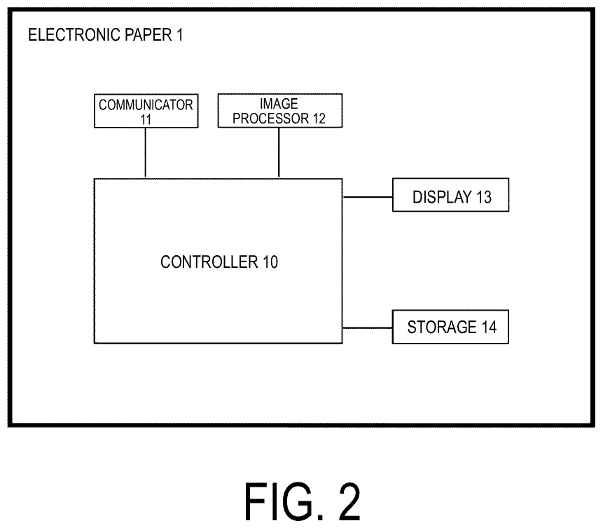

Hereinafter, an electronic paper system 100 including an electronic paper 1 provided with an image processor 12 which is an example of the image processing apparatus of the disclosure will be described with reference to FIGS. 1 and 2.

A display apparatus is not limited to the electronic paper system 100 as long as the display apparatus includes the image processor 12, and may be any device or terminal including a portable information terminal such as a smartphone or a tablet terminal, an electronic blackboard, an information display, a personal computer, or the like, or may be a system including these devices or terminals.

FIG. 1 is an explanatory diagram illustrating a schematic configuration of the electronic paper system 100 according to the first embodiment of the disclosure.

As illustrated in FIG. 1, the electronic paper system 100 includes the electronic paper 1 and a server 2 connected to each other via a network 3 of a wireless or wired manner.

### Configuration of Electronic Paper 1

FIG. 2 is a block diagram illustrating a schematic configuration of the electronic paper 1 in FIG. 1.

The electronic paper 1 includes a controller 10, a communicator 11, the image processor 12, a display 13, and a storage 14.

The electronic paper 1 may have a configuration in which power is supplied to each component from a commercial power supply, or may have a configuration in which power is supplied to each component from a battery.

Hereinafter, each component of the electronic paper 1 will be described.

The controller 10 collectively controls the electronic paper 1 and includes at least one central processing unit (CPU), at least one system on a chip (SoC), at least one random access memory (RAM), at least one read only memory (ROM), at least one control circuit, various interface circuits, and the like.

The controller 10 performs monitoring and control of all loads, such as detection of each sensor, in order to control operations of the entire electronic paper 1.

The communicator 11 is a part that transmits and receives data to and from the server 2 via the network 3. For example, the communicator 11 communicates with the server 2 and receives image data from the server 2.

The image processor 12 is a part that converts image data into an appropriate electric signal and performs processing such as enlargement or shrinking for appropriate outputting.

The image processor 12 includes a halftone (tone reproduction) processor 125.

The image processor 12 and the halftone (tone reproduction) processor 125 may be configured with electronic circuits.

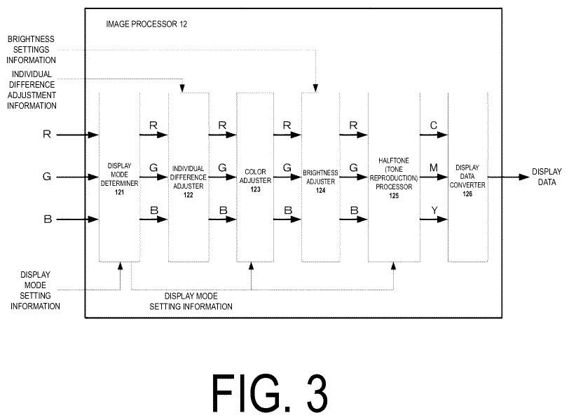

The detailed configuration and processing of the image processor 12 will be described below in the description of FIGS. 3 to 10.

The display 13 is a part that displays an image output from the image processor 12.

The display 13 is configured with a liquid crystal panel or the like.

The display 13 includes color particles (not illustrated) that move by being applied with a predetermined write voltage from a battery 15. The color particles are, for example, charged organic or inorganic particles, and a predetermined display image is displayed on the display 13 through electrophoresis in which the color particles move or rotate in a dispersion liquid (not illustrated) in response to the write voltage applied between two electrodes (not illustrated).

The display method of the display 13 is not limited to the electrophoretic method, and may be, for example, a particle rotation method of rotating charged particles or a magnetophoretic method of moving particles by magnetism.

The display 13 has an output method of expressing colors by mixing a plurality of color particles.

For example, when colors are expressed using four types of color particles of red, yellow, white, and blue, a voltage is applied to the charged color particles of each color to move the color particles in a dispersion liquid (not illustrated) of the display 13. Then, six colors of red, green, blue, yellow, white, and black can be output as described below by combining the color particles of the respective colors moved to the upper portion of the dispersion liquid.
White color particles=white output
Red color particles=red output
Yellow color particles=yellow output
Blue color particles=blue output
Combination of blue and yellow color particles=green output
Combination of blue and red color particles=black output

On the other hand, when colors are expressed by four types of color particles of yellow, cyan, magenta, and white, eight colors of red, green, blue, yellow, white, black, cyan, and magenta can be output by combining the color particles of the respective colors.
White color particles=white output
Combination of yellow and magenta color particles=red output
Yellow color particles=yellow output
Combination of cyan and magenta color particles=blue output
Combination of yellow and cyan color particles=green output
Combination of cyan, yellow, and magenta color particles=black output
Cyan color particles=cyan color output
Magenta color particles=magenta color output

The storage 14 is an element or a storage medium that stores information required to implement various functions of the electronic paper 1, a control program, and the like. For example, a semiconductor element such as a RAM or a ROM, or a storage medium such as a hard disk, a flash storage, or a solid state drive (SSD) is used.

Note that programs and data may be held in different devices, such as configuring a region for holding the data in a hard disk drive and a region for holding the programs in a flash storage.

In the electronic paper 1, image data of RGB (R: red, G: green, B: blue) acquired from the server 2 through the communicator 11 is output to the image processor 12 to be subjected to image processing, and an image output from the image processor 12 as a digital signal including pixels of the six colors or the eight colors is displayed on the display 13.

### Image Processing of Image Processor 12 of Electronic Paper 1 of First Embodiment of Disclosure

Next, a flow of image processing of the image processor 12 of the electronic paper 1 of the first embodiment of the disclosure will be described with reference to FIGS. 3 to 10.

FIG. 3 is a block diagram illustrating a schematic configuration of the image processor 12 in FIG. 1.

As illustrated in FIG. 3, the image processor 12 includes a display mode determiner 121, an individual difference adjuster 122, a color adjuster 123, a brightness adjuster 124, the halftone (tone reproduction) processor 125, and a display data converter 126.

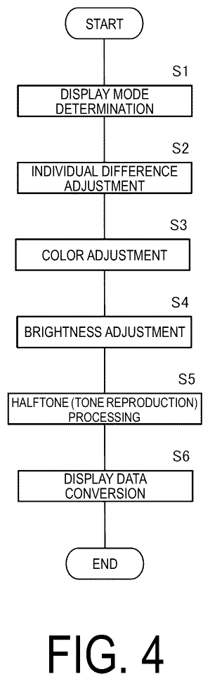

FIG. 4 is a flowchart illustrating an example of the image processing by the image processor 12 in FIG. 1.

In FIG. 4, when the image processing is started, in step S1, the controller 10 of the electronic paper 1 causes the display mode determiner 121 to determine a display mode of an image (step S1).

The types of display modes include display modes of “automatic”, “photograph”, “character (automatic)”, “character (gray)”, and “character (color)”, and setting information of the display mode set by a user is stored in the storage 14 in advance. The controller 10 determines the display mode with reference to the setting information of the display mode stored in the storage 14.

### Modification

As a modification, the electronic paper 1 may further include an image data determiner (not illustrated) that determines whether image data includes a character image based on an analysis result of an image data analyzer (not illustrated) that analyzes the image data.

In that case, the controller 10 determines the display mode with reference to the determination result by the image data determiner.

Next, in step S2, the controller 10 causes the individual difference adjuster 122 to perform individual difference adjustment processing (step S2).

The color characteristics of the electronic papers 1 differ for each individual. Thus, in order to reduce the individual difference, correction is performed using a 3D lookup table (3D LUT) or the like based on individual difference adjustment information in which a color measurement result of each individual at the time of mass production or the like is recorded.

Next, in step S3, the controller 10 causes the color adjuster 123 to perform color adjustment processing of performing correction suitable for display and correction to a tone according to the setting by the user (step S3).

Since the halftone processing varies depending on the display mode, the controller 10 may cause the color adjuster 123 to perform different correction depending on display mode setting information.

Next, in step S4, the controller 10 causes the brightness adjuster 124 to perform brightness correction processing according to brightness setting information by the user (step S4).

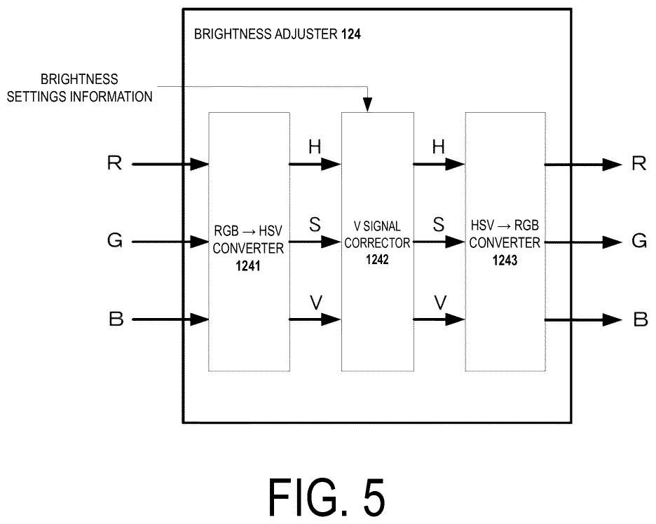

FIG. 5 is a block diagram illustrating a schematic configuration of the brightness adjuster 124 in FIG. 3.

As illustrated in FIG. 5, the brightness adjuster 124 includes an RGB→HSV converter 1241, a V signal corrector 1242, and an HSV→RGB converter 1243.

The RGB→HSV converter 1241 converts RGB data including respective signals of red, green, and blue into HSV data including respective signals of hue, saturation, and value.

Next, the V signal corrector 1242 adjusts the brightness by correcting the V (value) signal of the HSV data based on the brightness setting information.

Finally, the HSV→RGB converter 1243 converts the HSV data into RGB data and outputs the RGB data.

Next, in step S5 in FIG. 4, the controller 10 causes the halftone (tone reproduction) processor 125 to perform halftone (tone reproduction) processing (step S5).

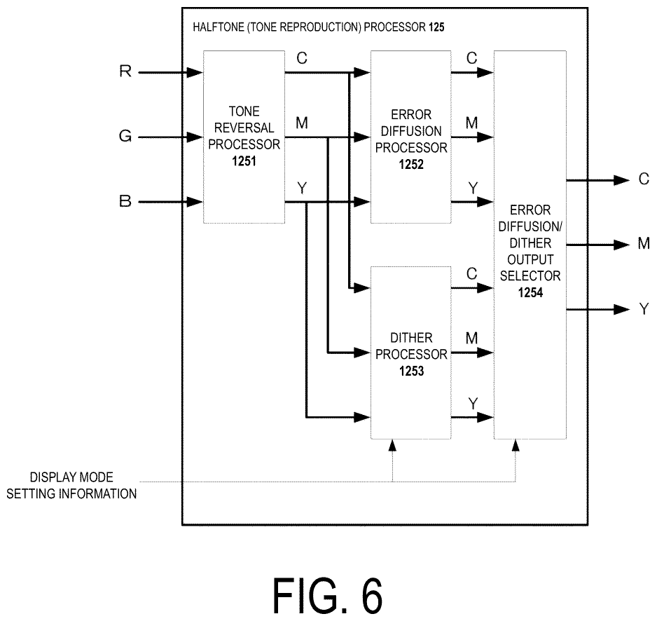

Details of the halftone (tone reproduction) processing will be described below in the description of FIGS. 6 to 10.

Next, in step S6, the controller 10 causes the display data converter 126 to perform display data conversion processing and outputs display data (step S6), and then ends the image processing.

FIG. 6 is a block diagram illustrating a schematic configuration of the halftone (tone reproduction) processor 125 in FIG. 3.

As illustrated in FIG. 6, the halftone (tone reproduction) processor 125 includes a tone reversal processor 1251, an error diffusion processor 1252, a dither processor 1253, and an error diffusion/dither output selector 1254.

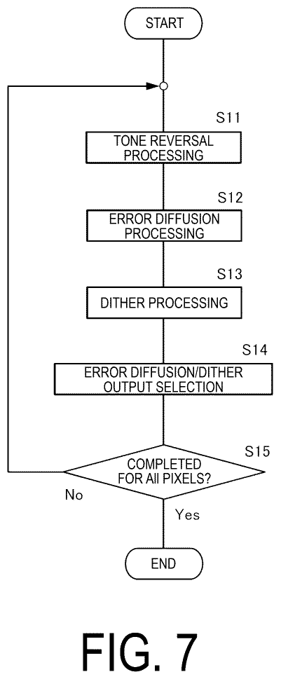

FIG. 7 is a flowchart illustrating an example of the halftone (tone reproduction) processing by the halftone (tone reproduction) processor 125 in FIG. 3.

In step S11 in FIG. 7, the controller 10 causes the tone reversal processor 1251 to perform tone reversal processing of converting from the RGB data to CMY data including respective signals of cyan, magenta, and yellow (step S11).

Specifically, the tone reversal processing is performed using the following expressions.

C=255−R

M=255−G

Y=255−B

Note that the halftone (tone reproduction) processing may be performed on the RGB data as it is without performing the tone reversal processing of converting from the RGB data to the CMY data.

Next, in step S12, the controller 10 performs error diffusion processing (step S12).

When the image data includes a character image, the error diffusion processing need not be performed.

### Error Diffusion Processing

The error diffusion processor 1252 quantizes the CMY values of each pixel of image data to any of quantized values of predetermined output colors, and diffuses an error of each of the three components to the subsequent pixels before quantization, thereby performing vector error diffusion processing of reproducing a smooth tone change.

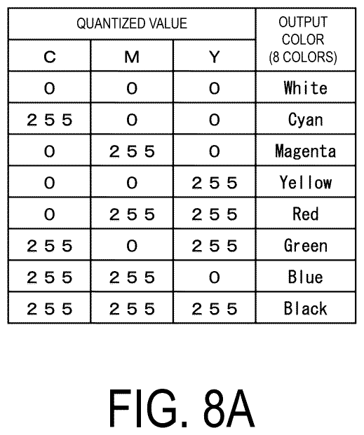

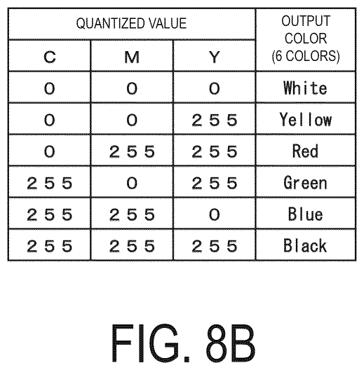

FIGS. 8A and 8B are tables each showing a correspondence relationship between quantized values of CMY values of respective pixels by the error diffusion processor 1252 in FIG. 6 and output colors of the display 13.

When the output colors are eight colors of white, cyan, magenta, yellow, red, green, blue, and black, the CMY values of each pixel of the image data is quantized to any of the quantized values of these output colors.

FIG. 8A illustrates a correspondence relationship between the quantized values and the output colors of the display 13 when the number of output colors is eight.

As illustrated in FIG. 8A, when a vector including three components of CMY is defined as (C, M, Y), the quantized values of the respective output colors are as follows.
White: (0, 0, 0)
Cyan: (255, 0, 0)
Magenta: (0, 255, 0)
Yellow: (0, 0, 255)
Red: (0, 255, 255)
Green: (255, 0, 255)
Blue: (255, 255, 0)
Black: (255, 255, 255)

The error diffusion processor 1252 determines a set of CMY quantized values of a color closest to input CMY values (having a small error) among the eight sets of CMY quantized values with respect to the CMY values of each pixel of the image data, and diffuses the errors of the three components to the subsequent pixels before quantization.

Then, the same processing is performed on the subsequent pixels before quantization.

On the other hand, when the output colors are six colors of white, yellow, red, green, blue, and black, the CMY values of each pixel of the image data is quantized to any of the quantized values of these output colors.

FIG. 8B illustrates a correspondence relationship between the quantized values and the output colors of the display 13 when the number of output colors is six.

As illustrated in FIG. 8B, when a vector including three components of CMY is defined as (C, M, Y), the quantized values of the respective output colors are as follows.
White: (0, 0, 0)
Yellow: (0, 0, 255)
Red: (0, 255, 255)
Green: (255, 0, 255)
Blue: (255, 255, 0)
Black: (255, 255, 255)

Next, in step S13, the controller 10 performs dither processing (step S13).

When the image data does not include a character image, the dither processing need not be performed.

### Problems in Vector Error Diffusion Processing

A large-sized electronic paper used for a poster or the like needs to display large and thick characters. However, when a character image of a large and thick character having intermediate density is subjected to vector error diffusion processing and output, the inside of the character may become non-uniform.

For example, even when an original image is a gray character image, pixels other than white and black pixels may be generated due to accumulated errors from quantized pixels in the vector error diffusion processing, and a desired result cannot be obtained. Therefore, for character images, it is desirable to perform systematic dither processing in which importance is placed on uniformity.

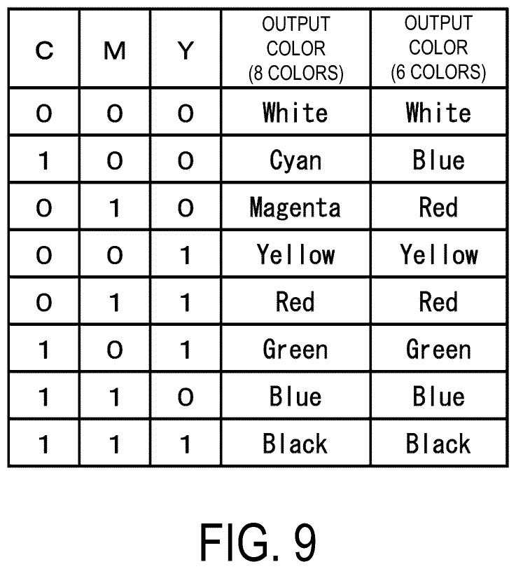

FIG. 9 is a table showing a correspondence relationship between CMY values after binarization of respective pixels through dither processing by the dither processor 1253 in FIG. 6 and output colors of the display 13.

As illustrated in FIG. 9, combinations of three components (C, M, Y) of the CMY values are associated with respective output colors (eight colors and six colors).

### (1) Eight Output Colors

(0, 0, 0): white
(1, 0, 0): cyan
(0, 1, 0): magenta
(0, 0, 1): yellow
(0, 1, 1): red
(1, 0, 1): green
(1, 1, 0): blue
(1, 1, 1): black

### (2) Six Output Colors

(0, 0, 0): white
(1, 0, 0): blue
(0, 1, 0): red
(0, 0, 1): yellow
(0, 1, 1): red
(1, 0, 1): green
(1, 1, 0): blue
(1, 1, 1): black

The systematic dither processing is dither processing of binarizing image data using a different threshold value for each pixel.

As a pattern of such threshold values, a Bayer type pattern in which dots are dispersed is known, and by using the Bayer type pattern, it is possible to secure the resolution of a character image, reduce the granular feeling of the image, and make the inside look uniform.

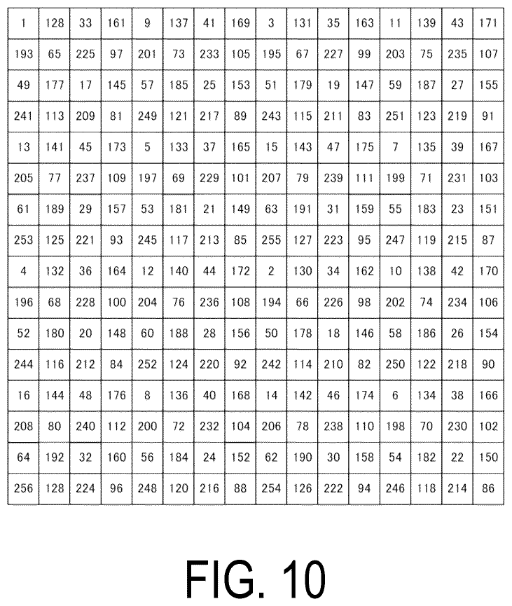

FIG. 10 is an example of a Bayer type threshold matrix used in the dither processing by the dither processor 1253 in FIG. 6.

After the dither processing in step S13 in FIG. 7 is completed, in step S14, the controller 10 causes the error diffusion/dither output selector 1254 to perform error diffusion/dither output selection processing (step S14).

When the display mode is “photograph”, the result of the error diffusion processing is output.

On the other hand, when the display mode is “character (automatic)”, “character (gray)”, or “character (color)”, the result of the dither processing is output.

Next, in step S15, the controller 10 determines whether the halftone (tone reproduction) processing has been completed for all the pixels (step S15).

When the halftone (tone reproduction) processing has been completed for all the pixels (when the determination in step S15 is Yes), the controller 10 outputs CMY data and ends the processing.

On the other hand, when the halftone (tone reproduction) processing has not been completed for all the pixels (when the determination in step S15 is NO), the controller 10 returns the processing to step S11.

In this way, by selecting the output of the dither processing when image data includes a character image and selecting the output of the error diffusion processing when image data does not includes a character image, it is possible to implement the electronic paper 1 including the image processor capable of performing halftone processing of image data more appropriately than in the related art.

### Second Embodiment

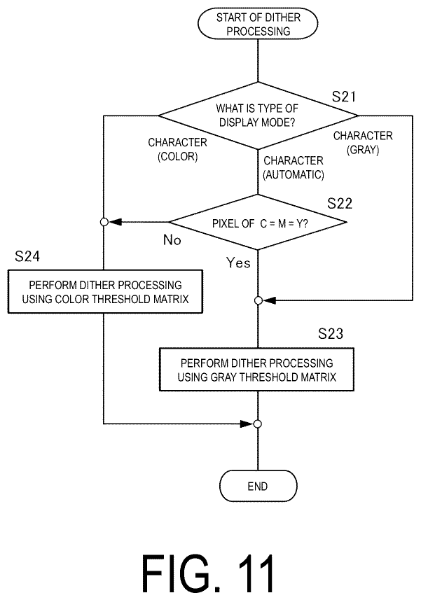

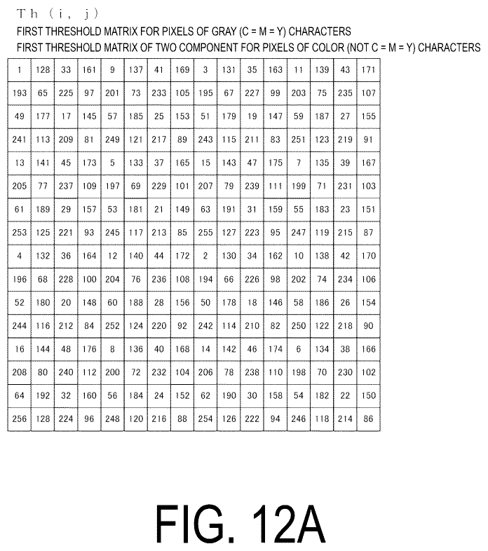

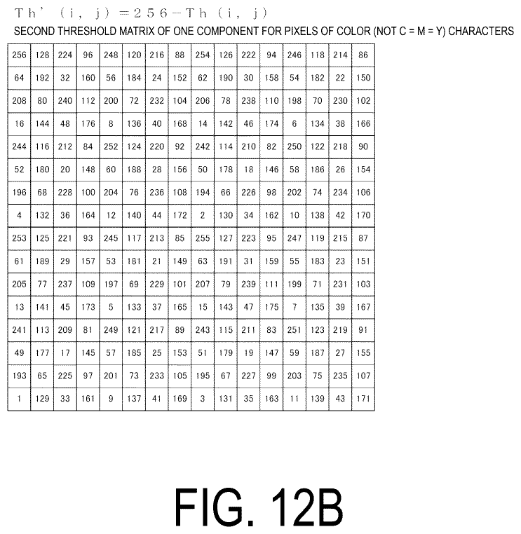

Next, the electronic paper system 100 according to a second embodiment of the disclosure will be described with reference to FIGS. 11, 12A and 12B.

In the electronic paper 1 of the first embodiment, the dither processing is performed using the same threshold matrix in both cases of color and gray character images.

Here, in the case of a color character image, when the dither processing is performed using the same threshold matrix for three components of CMY, the number of white/black pixels tends to increase, and thus there is a problem that the granular feeling is conspicuous and the saturation of the color character is lowered.

On the other hand, in a case where the pixels to be subjected to the dither processing are pixels of a gray character, when the dither processing is performed on even one component among three components of CMY using a different threshold matrix, color pixels may appear in the gray character, and the grayness may be impaired.

In order to avoid such problems, the electronic paper 1 of the second embodiment is characterized in that the dither processing is performed using an appropriate threshold matrix in accordance with a difference in pixels of color/gray characters.

The schematic configurations of the electronic paper system 100, the electronic paper 1, the image processor 12, the brightness adjuster 124, and the halftone (tone reproduction) processor 125 according to the second embodiment are the same as those of the first embodiment, and thus the descriptions thereof are omitted.

Further, the image processing of the image processor 12 of the electronic paper 1 and the halftone (tone reproduction) processing by the halftone (tone reproduction) processor are also the same as those of the first embodiment, and thus the descriptions thereof are omitted.

FIG. 11 is a flowchart illustrating an example of the dither processing by the dither processor 1253 of the image processor 12 of the electronic paper 1 of the second embodiment of the disclosure.

When the dither processing is started, in step S21 in FIG. 11, the controller 10 of the electronic paper 1 determine a type of the display mode (step S21).

When the type of the display mode is “character (automatic)” (when the determination in step S21 is “character (automatic)”), in step S22, the controller 10 determines whether the pixels to be subjected to the dither processing are pixels of a gray (C=M=Y) character (step S22).

When the pixels to be subjected to the dither processing are pixels of a gray (C=M=Y) character (when the determination in step S22 is Yes), the controller 10 performs the dither processing using a gray threshold matrix in step S23, and ends the processing.

In addition, when the type of the display mode is “character (gray)” in step S21, the processing of step S23 is also performed.

On the other hand, in step S22, when the pixels to be subjected to the dither processing are pixels of a color (not C=M=Y) character (when the determination in step S22 is No), the controller 10 performs the dither processing using a color threshold matrix in step S24, and ends the processing.

In addition, when the type of the display mode is “character (color)” in step S21, the processing of step S24 is also performed.

FIGS. 12A and 12B are examples of a Bayer type threshold matrix used by the dither processor 1253 of the image processor 12 of the electronic paper 1 of the second embodiment of the disclosure. FIG. 12A illustrates a first threshold matrix for pixels of gray (C=M=Y) characters or a first threshold matrix of two components for pixels of color (not C=M=Y) characters. FIG. 12B illustrates a second threshold matrix of one component for pixels of color (not C=M=Y) characters.

For pixels of a gray (C=M=Y) character, the dither processing is performed on three components of CMY using the same first threshold matrix as illustrated in FIG. 12A.

Accordingly, the pixels of the gray (C=M=Y) character are displayed with good uniformity of white pixels and black pixels only.

On the other hand, for pixels of a color (not C=M=Y) character, the dither processing is performed on pixels of two components (e.g., CY) among three components of CMY using the first threshold matrix, and the dither processing is performed on pixels of remaining one component (e.g., M) using the second threshold matrix different from the first threshold matrix as illustrated in FIG. 12B.

Arrangement of threshold values is differentiated between the first and second threshold matrices so that coincidence of output values after the dither processing is reduced as much as possible.

For example, the first and second threshold matrices may have a relationship in which the order of arranging respective threshold values is reversed, or a relationship in which respective threshold values are tone-reversed.

When an element of the first threshold matrix in FIG. 12A is Th (i, j), an element of the second threshold matrix in FIG. 12B is Th′ (i, j)=256−Th (i, j), showing the relationship in which respective threshold values are tone-reversed.

Accordingly, color (not C=M=Y) characters tend to have a low number of white/black pixels, and thus it is possible to suppress granular feeling and prevent a decrease in saturation of the color characters.

In this way, in the dither processing, when three color component values of a pixel are the same, the first dither processing is performed on all the three color component values using the first threshold matrix. On the other hand, when three color component values of a pixel are not the same, the second dither processing is performed on at least one color component among the three color component values using the second threshold matrix different from the first threshold matrix. Accordingly, it is possible to implement the electronic paper 1 including the image processor 12 capable of performing the halftone processing of image data more appropriately than in the related art.

### Third Embodiment

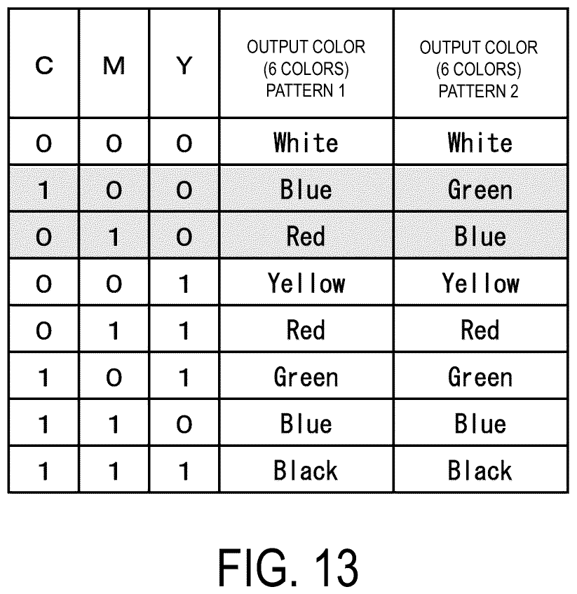

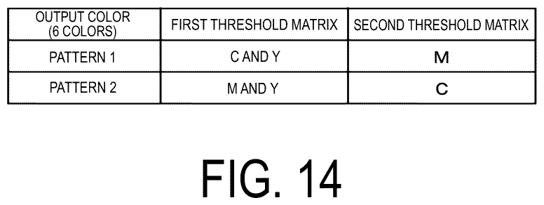

Next, the electronic paper system 100 according to a third embodiment of the disclosure will be described with reference to FIGS. 13 and 14.

Incidentally, when output colors are six colors of white, yellow, red, green, blue, and black, the CMY value of each pixel of image data needs to be quantized to any of the quantized values of these output colors.

However, since the output colors do not include cyan and magenta, these colors need to be forcibly converted into similar output colors after the dither processing.

FIG. 13 is a table showing a correspondence relationship between CMY values after binarization of respective pixels through the dither processing by the dither processor of the image processor 12 of the electronic paper of the third embodiment of the disclosure and output colors of the display 13.

As illustrated in FIG. 13, combinations (C, M, Y) of three components of CMY values are associated with respective output colors (six colors), and there are two patterns 1 and 2 as below.

### (1) Output Color (Six Colors) Pattern 1

(0, 0, 0): white
(1, 0, 0): blue
(0, 1, 0): red
(0, 0, 1): yellow
(0, 1, 1): red
(1, 0, 1): green
(1, 1, 0): blue
(1, 1, 1): black

### (2) Output Color (Six Colors) Pattern 2

(0, 0, 0): white
(1, 0, 0): green
(0, 1, 0): blue
(0, 0, 1): yellow
(0, 1, 1): red
(1, 0, 1): green
(1, 1, 0): blue
(1, 1, 1): black

However, depending on a combination of pixels of two components to be subjected to the dither processing using the first threshold matrix and pixels of one component to be subjected to the dither processing using the second threshold matrix among three components of CMY, an original image may be converted into a more grayish image due to a mixture of blue and yellow.

In order to avoid such a problem, the electronic paper 1 of the third embodiment is characterized in that the dither processing is performed using an appropriate threshold matrix for pixels having three components of CMY.

The schematic configurations of the electronic paper system 100, the electronic paper 1, the image processor 12, the brightness adjuster 124, and the halftone (tone reproduction) processor 125 according to the third embodiment are the same as those of the first embodiment, and thus the descriptions thereof are omitted.

Further, the image processing of the image processor 12 of the electronic paper 1 and the halftone (tone reproduction) processing by the halftone (tone reproduction) processor are also the same as those in the first embodiment, and thus the descriptions thereof are omitted.

FIG. 14 is a table showing an example of combinations of three components of CMY to be subjected to the dither processing using the first and second threshold matrices for each pattern of output colors (six colors) of the display 13 of the electronic paper 1 of the third embodiment of the disclosure.

As illustrated in FIG. 14, in the case of pattern 1 of the output colors (six colors), the dither processing is performed on pixels of cyan, which is a component to be forcibly converted into blue as a complementary color of yellow, using the first threshold matrix in common with yellow.

On the other hand, the dither processing is performed on pixels of magenta, which is a component to be forcibly converted into red, using the second threshold matrix.

In the case of pattern 2 of the output colors (six colors), the dither processing is performed on pixels of magenta, which is a component to be forcibly converted into blue as a complementary color of yellow, using the first threshold matrix in common with yellow.

On the other hand, the dither processing is performed on pixels of cyan, which is a component to be forcibly converted into green, using the second threshold matrix.

Note that the dither processing may be performed using the second threshold matrix for pixels of two components and using the first threshold matrix for pixels of the remaining one component.

In this way, for pixels of cyan or magenta, which is a component to be forcibly converted into blue as a complementary color of yellow, the dither processing is performed using the same threshold matrix as that used for yellow. Further, the threshold matrix used for the remaining one component of magenta or cyan is set to have different threshold value arrangement that reduces coincidence in output values after the processing as much as possible. As a result, it is possible to suppress grayness due to a mixture of yellow and blue.

In this way, when output colors are six colors, the dither processing is performed on pixels of color components having a complementary color relationship using the same threshold matrix, and the threshold matrix for pixels of the remaining one color component is set to have different threshold value arrangement that reduces coincidence in output values after the processing as much as possible. Accordingly, it is possible to implement the electronic paper 1 including the image processor 12 capable of performing the halftone processing of image data more appropriately than in the related art.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image processing apparatus comprising;
an image data acquirer that acquires image data; and
a halftone processor that performs dither processing when the image data includes a character image or does not include a photographic image, and performs error diffusion processing when the image data does not include a character image or includes a photographic image.

2. The image processing apparatus according to claim 1, wherein whether the image data includes a character image or whether the image data does not include a photographic image is determined based on a user's setting.

3. The image processing apparatus according to claim 1, further comprising:
an image data determiner that determines whether the image data includes a character image or whether the image data does not include a photographic image; and
an image data analyzer that analyzes the image data,
wherein the image data determiner determines whether the image data includes a character image or whether the image data does not include a photographic image based on an analysis result of the image data analyzer.

4. The image processing apparatus according to claim 1, further comprising a color component determiner that determines, when the image data includes a character image or does not include a photographic image, whether three color component values of pixel data constituting the character image are identical,
wherein the halftone processor performs predetermined first dither processing on the pixel data when the three color component values of the pixel data are identical, and perform predetermined second dither processing different from the first dither processing on the pixel data when the three color component values of the pixel data are not identical.

5. The image processing apparatus according to claim 4, wherein
the first dither processing is performed on all components of the three color component values using a predetermined first threshold matrix, and
the second dither processing is performed on at least one color component of the three color component values using a predetermined second threshold matrix different from the first threshold matrix.

6. The image processing apparatus according to claim 5, wherein the first threshold matrix and the second threshold matrix are Bayer type threshold matrices.

7. The image processing apparatus according to claim 1, further comprising an image data output unit that converts the image data processed by the halftone processor into output image data and outputs the output image data.

8. A display apparatus comprising:
the image processing apparatus according to claim 7; and
a display that displays an image based on the output image data.

9. An electronic paper comprising:
the image processing apparatus according to claim 7; and
a display that displays an image based on the output image data,
wherein the display includes color particles that move by being applied with a predetermined write voltage, and
wherein the image is displayed on the display by applying the write voltage to the color particles based on the output image data.

10. An image processing method comprising:
acquiring image data; and
performing dither processing when the image data includes a character image or does not include a photographic image, and performing error diffusion processing when the image data does not include a character image or includes a photographic image.

11. A non-transitory computer readable medium storing an image processing program that causes a processor of an image processing apparatus to execute processing, the processing comprising:
acquiring image data; and
performing dither processing when the image data includes a character image or does not include a photographic image, and performing error diffusion processing when the image data does not include a character image or includes a photographic image.
